(19) United States
(12) Patent Application Publication
(10) Pub. No.: US 2018/0265328 A1
(43) Pub. Date: Sep. 20, 2018

(54) ELEVATOR ARRANGEMENT ADAPTED FOR SOUND-BASED DETERMINING OF POSITIONS OF FIXTURES AT VARIOUS FLOORS

(71) Applicant: Inventio AG, Hergiswil (CH)

(72) Inventors: Vimal Patel, Parsippany, NJ (US); Nicolas Gremaud, Richterswil (CH)

(21) Appl. No.: 15/763,217

(22) PCT Filed: Sep. 23, 2016
(86) PCT No.: PCT/EP2016/072640

§ 371 Date: Mar. 26, 2018

(30) Foreign Application Priority Data
Sep. 28, 2015 (EP) 15187122.5

(51) Int. Cl. B66B 1/34; B66B 9/00; B66B 19/00; B66B 13/14

(52) U.S. Cl. CPC B66B 1/3492; B66B 9/00; B66B 13/143; B66B 19/00; B66B 1/3407

(57) ABSTRACT

An elevator arrangement includes a car, an elevator control having car position current information, a plurality of fixtures, at least one sound generator at one of the car and each of the fixtures, and at least one sound detector at the other of the car and each of the fixtures. A fixture position learning procedure includes: travelling the car to and, preferably, stopping at each of the floors; at each floor stop, generating a sound signal from the sound generator at the car or the fixture at the floor stop, detecting the sound signal using the sound detector, determining a position information for the fixture at the floor stop by assigning information on a current position of the car from the elevator control, and storing the position information for subsequent identification purposes, whereby the identity/position of each of the fixtures is determined in the automatically performed learning procedure.

### FIELD

The present invention relates to an elevator arrangement. Particularly, the present invention relates to determining positions of various fixtures of the elevator arrangement. Furthermore, the invention relates to a method for determining such position information, to a computer program product enabling automated performing of such method and to a computer-readable medium comprising such computer program product stored thereon.

### BACKGROUND

Elevators are typically used for transporting persons or items between various levels, i.e. for vertically transporting people or items in an elevator car for example between floors within a building.

Generally, at each of the floors, fixtures are provided. Such fixtures may serve various purposes. For example, a fixture may be provided in a form of a landing operating panel (LOP) and may be used by passengers in order to call a car of the elevator to come to a specific floor. Such landing operating panels typically comprise one or more call buttons or other means for determining a user's request.

Other fixtures may serve for providing information to a user. For example, such fixtures may comprise a display, lights, indicators, loudspeakers etc. and may indicate information for example about a current position of the elevator car, its moving direction, its estimated time of arrival, etc. Other fixtures may be provided within the floors of the building for further purposes.

Typically, in order to be able to properly operate, an elevator arrangement must have information about the positions of each of its fixtures. For example, in order to be able to correctly control a motion of the elevator car, an elevator control must know the position of the LOP at which a passenger has pushed a call button. Only when the position of such fixture is known to the elevator control, the elevator control can control driving the car to the floor where the user is waiting.

Generally, it is beneficial to provide all fixtures serving for a same or similar purpose within a building with an identical hardware. Accordingly, when installing the elevator arrangement, each fixture may be mounted at any of the various floors within the building. This may save costs and simplify logistics.

However, after installation, as the elevator control can initially not distinguish between the various fixtures located at the various floors, it is generally necessary to identify the position of each of the fixtures of the elevator arrangement such that, during subsequent normal operation of the elevator control, such information may be used by the elevator control for correctly controlling for example a car motion.

Conventionally, identifying the position of a fixture has been carried out for example by means of several switches being included into each of the fixtures wherein a switching state of the switches provided for a unique identification pattern upon which the elevator control could distinguish between the various fixtures. In such conventional approach, installation personnel had to manually set in each instance and at every floor the several switches of each of the fixtures. Configurations manually carried out in such manner required a high outlay in terms of time and personnel. Furthermore, the switches represented costly components.

An alternative approach is described in U.S. Pat. No. 7,699,143 B2 disclosing a method of setting the floor associations of a plurality of operating units of an elevator installation.

There may be a need for an elevator arrangement which enables determining of position information of fixtures located at various floors in a simple manner. Particularly, there may be a need for such elevator arrangement in which position information determination may be provided with minimum human labor, i.e. preferably semi-automatically or fully automatically. Furthermore, there may be a need for an elevator arrangement in which such position information determination may be provided at relatively low cost and/or at short time. Furthermore, there may be a need for a corresponding method for determining position information, for a computer program product enabling such method when executed on a programmable elevator control and for a computer-readable medium comprising such computer program product stored thereon.

### SUMMARY

According to a first aspect of the present invention, an elevator arrangement is proposed. The elevator arrangement comprises a car, an elevator control, a plurality of fixtures, at least one sound generator and at least one sound detector. The car is displaceable between various floors within a building. The elevator control controls displacements of the car between the various floors and has information on a current position of the car. Each of the fixtures is located at one of the floors and is connected to the elevator control for an exchange of information. The at least one sound generator is provided either at the elevator car or at each of the fixtures. Correspondingly, the sound detector is provided at the other one of the elevator car and each of the fixtures. In other words, in case a sound generator is provided at the elevator car, each of a plurality of sound detectors is provided at an associated one of the fixtures. Alternatively, if a plurality of sound generators is provided one at each of the fixtures, an associated sound detector is provided at the elevator car. The elevator arrangement is adapted to perform a fixture position learning procedure comprising the following steps: The car is travelled to each of the floors and is, preferably, stopped there. Then, at each of the floors, a sound signal is generated using the sound generator provided at the respective one of the car and an associated one of the fixtures located at the floor where the car is currently stopped. The sound signal is then detected using the sound detector provided at a respective other one of the car and the associated one of the fixtures located at the floor where the car is currently stopped. A position information for the associated fixture located at the floor where the car is currently stopped is then determined by assigning an information on a current position of the elevator car, such information being provided by the elevator control, to the associated fixture. Such determined position information is finally stored for subsequent identification purposes.

Ideas underlying embodiments of the present invention may be interpreted as being based, inter alia, on the following observations and recognitions.

As indicated in the introduction above, it may be beneficial to enable an elevator arrangement to semi- or fully-automatically learn the positions of each of its fixtures, i.e. to enable the elevator arrangement to uniquely identifying each of its fixtures and having information for example about the floor at which the fixture is arranged and/or a side location at which the fixture is arranged adjacent to an elevator shaft.

In order to enable such deriving of position information for each of the elevator arrangement's fixtures, it is suggested to include a sound transceiver arrangement comprising a sound generator for emitting a sound signal and a sound detector for receiving and detecting the sound signal into the elevator arrangement. Therein, either the sound generator or the sound detector is comprised in the displaceable elevator car, a position of which is generally known to the elevator control. The other component, i.e. the sound detector or the sound generator, respectively, is provided one at each of the fixtures located at the various floors. Such sound transceiver arrangement may then be used in a fixture position learning procedure in order to uniquely identify position information for each of the fixtures comprised in the various floors.

For example, according to an embodiment of the invention, the elevator arrangement may be adapted to, during performing the fixture position learning procedure, open an elevator door after having travelled to a specific one of the various floors in order to establish a direct sound connection between an interior of the elevator car and the associated floor at which the elevator car is currently stopped.

Accordingly, a sound signal generated for example by a sound generator arranged within the elevator car may reach a sound detector comprised in a fixture arranged at the associated floor without being substantially acoustically damped. Similarly, in case, vice versa, the sound generator is comprised in the fixture arranged at the associated floor, a sound signal generated thereby may travel towards the sound detector arranged within the elevator car without being significantly damped.

Therein, the term “direct sound connection” may be interpreted in that no substantial acoustical damping occurs on an acoustical path between the sound generator and the sound detector. For example, such acoustical damping along the direct sound connection shall be significantly less than between a sound generator and a sound detector not being established along a direct sound connection, i.e. being established for example between the elevator car and a non-associated floor at which the elevator car is not currently stopped. For example, an acoustical damping along a direct sound connection may be less than 20 dB, preferably less than 10 dB or even less than 5 dB. In contrast hereto, a non-direct sound connection typically establishes significantly more acoustical damping, for example more than 5 dB or even more than 10 dB higher acoustical damping than a direct sound connection.

According to an embodiment of the invention, it may also be feasible to not or to only partially open the elevator door, in particular to only partially open the elevator door so that no possible passenger could enter the car or even introduce body parts into the opening. In other words, according to an embodiment, the elevator arrangement is adapted to, during performing the fixture position learning procedure, only partially open or not open an elevator door, while a direct sound connection between an interior of the elevator car and the associated floor at which the elevator car is currently stopped is provided due to the elevator car being arranged at the associated floor.

Thus, e.g. the door may be opened only a few centimeters or even only a few millimeters so to hinder a person from entering or introducing, e.g. a hand or fingers into the opening. Such a partially opened door or even a closed door arranged at a specific floor may provide the effect of a direct sound connection simply due to the fact of the car being in the vicinity of the LOP behind the shaft door of the current floor, while being at a certain distance from LOPs on others floors, in particularly not directly being behind shaft doors on other floors. The car door together with a possibly mechanically connected, e.g. mechanically touching, shaft door may thus transmit in the way of structure-borne sound through the doors from the inside of the to the landing and/or vice versa, thereby establishing, at least the effect of, a direct sound connection.

It is noted, that in all embodiments an opened door may be equally only partially opened or not opened at all as long as the effect of the direct sound connection as describes above is provided. Thus, the learning procedure may include stops at the individual floors without opening the doors on said landing.

According to an embodiment, a sound detector is comprised in each of multiple fixtures provided at each of multiple floors and the sound generator is comprised in the elevator car. In such embodiment, the elevator arrangement is adapted to, during performing the fixture position learning procedure, generate the sound signal using the sound generator and determining the position information for one of the fixtures by assigning the information on the current position of the car to the specific one of the fixtures detecting the generated sound signal with a highest sound pressure level.

In other words, during the fixture position learning procedure, the sound generator comprised in the elevator car may emit its sound signal. In principle, this sound signal may be detected, i.e. “heard”, at each of the sound detectors comprised in the various fixtures at the various floors. However, the closer a sound detector is to the sound generator, the lower an acoustical damping on an acoustical path between the sound generator and the respective sound detector will be. This is particularly true in case, preceding to generating the sound signal, the elevator door has been opened in order to establish a direct sound connection between the elevator car and the associated floor. Accordingly, the sound detector comprised in the fixture arranged in the associated floor being located directly adjacent to the elevator car's current position will detect the emitted sound signal with a highest sound pressure level. Other sound detectors comprised in the fixtures at different floors being further away from the elevator car's current position may also detect the sound signal but with a lower sound pressure level.

Accordingly, based on a magnitude of the sound pressure level of the sound signal detected at each of the fixtures, the elevator control may determine the specific fixture being located closest to the elevator car's current position. As this elevator car's position is generally known to the elevator control, the elevator control then knows the position of the fixture arranged at the associated floor and may store such position information for subsequent identification purposes of the fixture.

In an alternative embodiment, the sound detector is comprised in the elevator car and a sound generator is comprised in each of multiple fixtures provided at each of the multiple floors. In such embodiment, the elevator arrangement is adapted to, during performing the fixture position learning procedure, generate sound signals using sequentially each of the sound generators. The position information for a specific one of the fixtures is then determined by assigning the information on a current position of the car to the specific one of the fixtures for which, when its sound generator generates the sound signal, the generated sound signal is detected with a highest sound pressure level.

In other words, in such embodiment, there is only one sound detector, this sound detector being comprised in the elevator car. On the other hand, a multiplicity of sound generators is provided, each sound generator being arranged at one of various fixtures provided at each of the multiple floors of the building. For example, such sound generator may be implemented with loudspeakers, gongs, horns, buzzers, or similar provided at the various floors e.g. for announcing the car's arrival during normal operation of the elevator arrangement.

With such specific sound transceiver arrangement, a fixture position learning procedure may be performed in a specific way by sequentially generating sound signals at each of the sound generators provided at the various floors. For example, the fixture position learning procedure may start by generating a sound signal with the sound generator comprised in the fixture at an uppermost floor of the building and may then proceed to generate sound signals sequentially at lower floors until finally generating the sound signal at a lowermost floor. During such sequential sound generation at various locations, the elevator car is parked at one of the floors. Possibly, its elevator door may be opened in order to establish a direct sound connection to this associated floor. Accordingly, the sound detector comprised in the elevator car will “hear” the sound signal loudest, i.e. will detect the sound signal with a highest sound pressure level, in case the sound signal is generated at the sound generator comprised in the fixture arranged at the associated floor where the elevator car is currently parked. By for example comparing the sound pressure level of this specific sound signal with sound pressure levels of sound signals detected precedingly or subsequently, the elevator control may then determine the position information of the fixture generating the sound signal with the highest sound pressure level by assigning the known current position of the elevator car to this fixture.

According to an embodiment, each of the fixtures and the elevator control are adapted to, when determining the position information, requesting the information on a current position of the car from the elevator control and assigning it to the associated one of the fixtures, i.e. the fixture at the floor where the car is currently stopped, and storing such information for subsequent identification purposes.

In other words, upon having determined, in the fixture position learning procedure, which one of the various fixtures is positioned at the floor where the elevator car is currently stopped, and as the elevator control generally knows the position of the elevator car, this position information may then be attributed to the determined fixture.

In alternative words, all fixtures may send their detector measurement results to the elevator control and the elevator control may then evaluate these signals in order to determine for example which of the fixtures provided for the sound signal being detected with a highest sound pressure level. Based on such signal evaluation, the elevator control may assign the information on the current position of the car to the fixture having provided the sound signal measurement with the highest sound pressure level. The assigned position information determined during such fixture position learning procedure may then be stored for example within the respective fixture such that, in subsequent normal operation of the elevator, the elevator control may request such information for subsequent identification purposes.

According to another embodiment, each of the fixtures is adapted to, when determining the position information, transmitting a unique identification information of the associated one of the fixtures to the elevator control and the elevator control is adapted to storing the unique identification information for subsequent identification purposes.

In other words, in such embodiment, when detecting the sound signal at the sound detector comprised in the elevator car or at sound detectors comprised in each of the fixtures comprised in the various floors, respectively, a signal representing the sound pressure level for example may be transmitted together with a unique identification information uniquely identifying the respective fixture which has emitted or detected the sound signal. The elevator control may then evaluate the various sound signal measurements and, by taking into account the information on the current position of the elevator car, may determine the position information for each of the fixtures. However, in such embodiment, the elevator control may not necessarily transmit the determined position information to each of the fixtures but, instead, may store this position information together with a respective unique identification information of the associated fixtures. For example, such information may be stored within a memory comprised in the elevator control and may be stored as a list or look-up table comprising, for each of the floors of the building, the unique identification information of the fixture arranged at the respective floor.

Independently on how the fixture position learning procedure is performed in detail, in a normal operation mode, the elevator control may be adapted to identify each of the fixtures based on the position information stored for subsequent identification purposes during such fixture position learning procedure.

In other words, during normal operation of the elevator arrangement, in order to identify the identity and/or location of for example a fixture which has been activated by a passenger waiting on one of the floors, the elevator control may either obtain information about such identity and/or location of the fixture from the fixture itself as such information has been previously stored in the fixture as a result of the fixture position learning procedure. Or, alternatively, the elevator control already comprises a list or look-up table linking a unique identification information for each of the fixtures with the information about the location of the respective fixtures such that, by consulting such look-up table, the elevator control may determine to which floor the elevator car has to be sent.

According to an embodiment, the fixture position learning procedure including the travelling of the car to each of the floors and the generating and detecting of the sound signals is performed automatically under control of the elevator control.

In other words, the fixture position learning procedure may be performed by the elevator arrangement without necessarily any human interaction, i.e. fully automatically, or with only limited human interaction, i.e. semi-automatically. Accordingly, when the elevator arrangement is installed within a building, the fixture position learning procedure may be initiated and may then automatically determine position information for all of the fixtures included in the elevator arrangement.

According to a specific embodiment the elevator car comprises at least two car doors. Therein, in the fixture position learning procedure, both car doors are opened at travelled-to floors sequentially, i.e. one after the other. Sound signals are then generated and detected using the sound generator and the sound detector, respectively, provided at a respective one of the car and an associated one of the fixtures located at the floor where the car is currently stopped and where the car door is currently opened.

In other words, in the fixture position learning procedure, the car is travelled to one of the floors and is stopped there. Then, a first one of the car doors is opened and a sound signal is generated. Therein, depending on the type of embodiment, the sound signal is generated within the elevator car or within each of the fixtures at the various floors and the sound generator provided at the respective other one of the elevator car and the fixtures is used for detecting such sound signal. Based on for example detecting the sound signal with a highest sound pressure level, it may then be determined whether one of the fixtures is located at a floor where the car is currently stopped and where the car door is currently opened. A corresponding position information may then be stored for subsequent identification purposes. Then, this car door may be closed again and another car door of the elevator car may be opened and the fixture position learning procedure may be repeated in order to determine position information for a fixture located next to this secondly opened car door.

Accordingly, in such specific embodiment, the position information may be determined by additionally correlating an information on which car door is currently opened, this information being generally provided by the elevator control.

According to a second aspect of the invention, a method for determining position information for each of a plurality of fixtures of an elevator arrangement is proposed. Therein, the fixtures are located at various floors within a building. The method comprises: First, travelling the car to each of the floors and, preferably, stopping the car there. Then, at each of the floors, generating a sound signal using a sound generator provided at a respective one of the car and an associated one of the fixtures located at the floor where the car is currently stopped and detecting the sound signal using a sound detector provided at a respective other one of the car and the associated one of the fixtures located at the floor where the car is currently stopped. Then, the position information for the associated fixture located at the floor where the car is currently stopped may be determined by assigning an information on a current position of the elevator car provided by the elevator control to the associated fixture. Finally, such position information may be stored for subsequent identification purposes for each of the fixtures.

Such position information determination method may be specifically applied for use with an elevator arrangement according to an embodiment of the present invention. Particularly, the method may be performed semi-automatically or fully-automatically. Therein, each of the method steps may be controlled for example by the elevator control of the elevator arrangement.

According to a third aspect, a computer program product is described. Such computer program product comprises computer-readable instructions which are adapted to, when executed by a processor of e.g. a programmable elevator control, controlling the method according to the above described second aspect of the invention.

Such computer program product may comprise computer-readable instructions in any programming language. The instructions may instruct the programmable elevator control to control travelling of the car, opening of car doors and determining of position information by correlating information on emitted and detected sound signals with information on a current position of the elevator car.

According to a fourth aspect of the present invention, a computer-readable medium comprising a computer program product according to the above-mentioned third aspect of the invention stored thereon is suggested. Such computer-readable medium may be any physical memory which allows storing computer-readable instructions, preferably electrically or magnetically, and/or which enables downloading of such computer-readable instructions. For example, the computer-readable medium may be a CD, a DVD, flash memory, EPROM, EEPROM, parts of the internet providing download options or similar.

It shall be noted that possible features and advantages of embodiments of the invention are described herein partly with respect to an elevator arrangement and partly with respect to a method for determining position information for each of a plurality of fixtures of an elevator arrangement. One skilled person will recognize that features described for one embodiment may be suitably transferred, adapted, or modified for application with other embodiments and/or may be combined and/or replaced with other features described for other embodiments in order to come to further embodiments of the invention.

In the following, advantageous embodiments of the invention will be described with reference to the enclosed drawings. However, neither the drawings nor the description shall be interpreted as limiting the invention.

### DESCRIPTION OF THE DRAWINGS

FIG. 1 shows a cross-sectional view through an elevator arrangement according to an embodiment of the present invention.

FIG. 2 shows a front view onto an opened elevator car and a fixture of an elevator arrangement according to an embodiment of the present invention.

FIG. 3 shows a front view onto an opened elevator car and a fixture of an elevator arrangement according to an alternative embodiment of the present invention.

The figures are only schematic and not to scale. Same reference signs refer to same or similar features.

### DETAILED DESCRIPTION

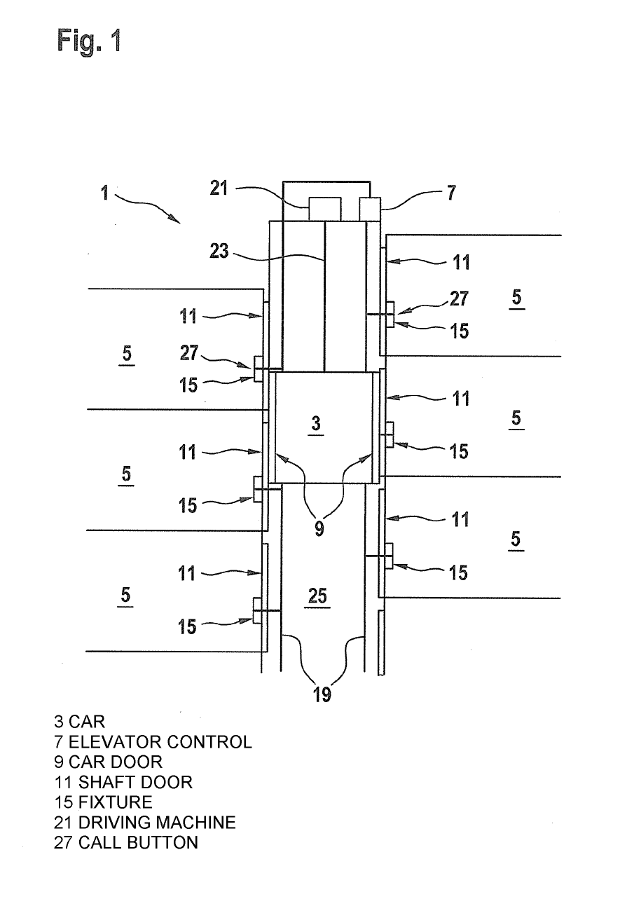

FIG. 1 shows an elevator arrangement 1 according to an embodiment of the present invention. The elevator arrangement 1 comprises a car 3 which is held by a suspension member 23 such as a rope or belt and which may be vertically displaced within an elevator shaft 25 to different levels corresponding to various floors 5 within a building using a driving machine 21 driving the suspension member 23. An elevator control 7 may control the displacements of the car 3 between the various floors 5. In order to be able to precisely control such displacements, the elevator control 7 has precise information on a current position of the car 3 available. For example, the elevator control 7 precisely knows where the car 3 is actually positioned within the elevator shaft 25, i.e. at which of the floors 5 the car is currently stopped or between which of the floors 5 the car 3 is currently displaced.

The car 3 has at least one car door 9. This car door 9 may be opened and closed. The opening and closing of the car door 9 may be controlled e.g. by the elevator control 7.

In the example given in FIG. 1, the car 3 has two car doors 9 disposed at opposite sides of the car 3. While a front side car door 9 may be opened to enable access to floors 5 at a front side of the building, another car door 9 at the rear side of the car 3 may enable access to floors 5 at a rear portion of the building. The floors 5 at the front portion and at the rear portion of the building may or may not be displaced in a vertical direction with respect to each other.

While the car doors 9 are attached to the car 3 and may be moved together with the car 3 within elevator shaft 25, shaft doors 11 are provided at shaft door openings at each of the floors 5 and are therefore fixedly connected to the building structure. These shaft doors 11 may also open and close. Particularly, the shaft doors 11 are configured to be opened and closed together with one of the car doors 9 when the car 3 is located at a respective floor 5.

At each of the floors 5, fixtures 15 are located. These fixtures 15 are connected to the elevator control 7 for an exchange of information. For example, each fixture 15 may be connected to the elevator control 7 via a hard-wiring 19. In the example given, the fixtures 15 are landing operating panels (LOP) comprising a call button 27 for ordering the car 3 to be moved towards a respective floor 5. However, other fixtures 15 may be provided within the floors 5 and may serve for different purposes.

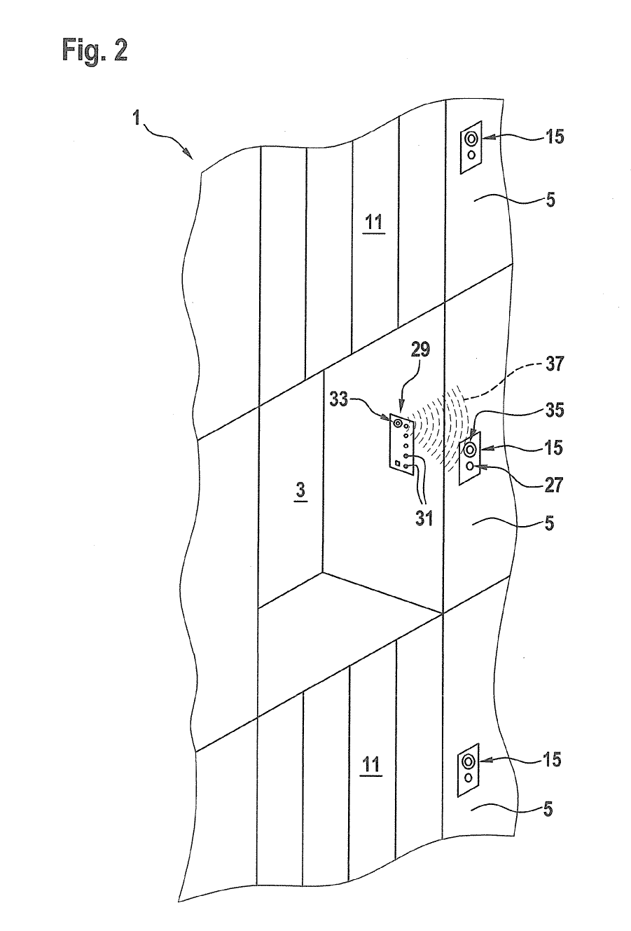

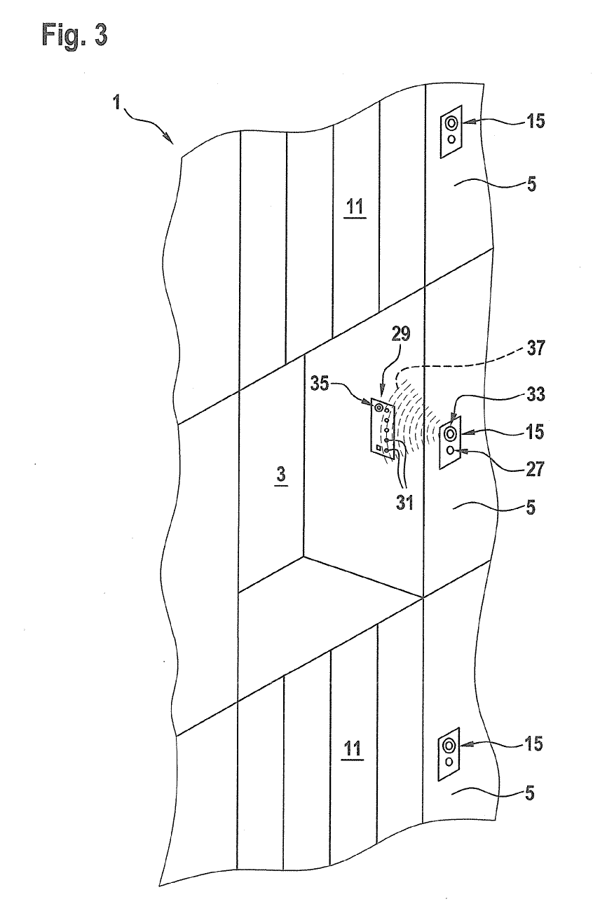

Details on embodiments of the elevator arrangement 1 and of fixture position learning procedures to be performed therewith will now be described with reference to FIGS. 2 and 3.

FIGS. 2 and 3 show front views onto a portion of an elevator arrangement 1 wherein the elevator car 3 has been stopped at one of the floors 5 and its car doors 9 and shaft doors 11 have been opened. In the other floors 5 where the car 3 is not currently stopped, the shaft doors 11 are closed.

Inside the elevator car 3, a car operating panel (COP) 29 is provided. The COP 29 comprises a plurality of selection buttons 31 with which a passenger may select e.g. a floor 5 to which he wants to travel. Additionally, the COP 29 comprises a sound generator 33 such as a loudspeaker.

On the floor 5 at a location close to the elevator shaft, i.e. close to an associated shaft door 11, a fixture 15 formed by a landing operating panel (LOP) is provided. Additionally to the call button 27, the LOP comprises a sound detector 35 such as a microphone. Fixtures 15 all comprising a same hardware may be provided at the various floors 5.

In such embodiment, in order to determine a position information for each of the fixtures 15 indicating where, i.e. at which of the floors 5, a respective fixture 15 is located, a fixture position learning procedure may be initiated for example after installing the elevator arrangement within the building. In such fixture position learning procedure, the elevator car 3 is driven by the elevator control 7 to travel to each of the floors 5, stop there and open its elevator doors 9 together with associated shaft doors 11.

Then, at each of the floors 5 and with a direct sound connection being established between the interior of the elevator car 3 and the associated floor 5 at which the elevator car 3 is currently stopped, the sound generator 33 comprised within the car 3 is controlled to emit a sound signal 37. For example, the elevator control 7 may control the COP's 29 sound generator 33 to emit a specific sound signal comprising for example a specific acoustical spectrum and/or a specific time-dependent sound pattern.

The sound signal 37 will be detected by the sound detectors 35 comprised in the fixtures 15. While, in principle, the sound signal 37 may be detected at various fixtures 15 arranged at neighboring floors 5, the associated fixture 15 arranged at the floor 5 at which the elevator car 3 is currently stopped will detect the sound signal 37 with a highest sound pressure level compared to sound detectors comprised in fixtures 15 arranged at floors at which the elevator car 3 is not stopped.

Accordingly, by comparing the sound signals 37 detected by the various sound detectors 35 comprised in the various fixtures 15, the elevator control 7 may easily identify the fixture 15 which is closest to the elevator car 3. As the elevator control 7 generally has information about where the elevator car 3 is currently stopped, the elevator control 7 may therefore determine the position information for this specific associated fixture 15.

For example, the elevator control 7 may transmit such position information to the associated fixture 15 and the associated fixture 15 may store this position information in a memory such that, upon later normal operation of the elevator arrangement 1, each fixture 15 may provide its position information to the elevator control when for example transmitting an elevator request upon the call button 27 being pressed. Alternatively, the elevator control 7 may store the position information together with a unique identification information which is provided by the associated one of the fixtures 15 to the elevator control 7 upon determining that this associated fixture is located at the position where the car 3 is currently stopped. The elevator control 7 may then store a look-up table in which a position information is assigned to a unique identification information for each of the various fixtures 15.

As soon as the position information has been determined for a specific fixture 15, the fixture position learning procedure will be continued by travelling the elevator car 3 to a next one of the floors 5 and determining the position information for the fixture 15 provided at this next floor. Such procedure may be repeated until the position information for all fixtures 15 at all floors 5 has been determined.

The embodiment shown in FIG. 3 differs from the embodiment of FIG. 2 in hardware mainly in that the sound generator 33 is not comprised within the elevator car 3, for example in its COP 29, but at each of the fixtures 15 provided at the various floors 15. Consequently, the sound detector 35 is comprised within the elevator car, for example within its COP 29.

In such embodiment, the fixture position learning procedure may differ from that described above with respect to the embodiment of FIG. 2. Similarly to the above described embodiment, the elevator car 3 is travelled to and stopped at each of the floors 5 and, preferably, its elevator doors 9 and shaft doors 11 are opened at a floor where the elevator car is currently stopped.

However, in contrast to the above described embodiment, a sound signal 37 is not only generated once during the elevator car 3 being stopped at a specific floor 5. Instead, for example the elevator control 7 controls each of the fixtures 15 to emit sound signals 37 using their associated sound generators 33 in a time sequence. For example, first, a sound signal 37 is generated at an uppermost fixture 15, then, for example one second later, a sound signal is generated at a fixture 15 one floor below this uppermost floor 5, and so on. The sound detector 35 in the elevator car 3 may “listen” to such sequence of sound signals 37. Accordingly, the sound detector 35 may determine when a sound signal 37 is detected with a highest sound pressure level.

Knowing, on the one hand, where the elevator car 3 is currently stopped and knowing, on the other hand, which one of the fixtures 15 has emitted the sound signal 37 being detected with the highest sound pressure level, the elevator control 7 may assign the position information to the respective one of the fixtures 15.

While not explicitly shown in the figures, the elevator arrangement 1 and its fixture position learning procedure may be specifically adapted for cases where two or more car doors 9 are provided within the elevator car 3. In such case, the position information may be determined not only based on an information about the current position of the elevator car 3 but also taking into account an information about which one of the elevator doors 9 is currently opened. It may be assumed that due to the direct sound connection between the fixture 15 at the floor 5 and the COP 29 in the elevator car 3 generated by opening the car door 9 and the shaft door 11, a sound signal 37 is detected with a significantly higher sound pressure level than is the case for a different fixture 15 arranged adjacent to the closed one of the elevator doors 9.

Briefly summarized and using a different wording, an elevator system is described which may automatically learn fixtures floor and side locations. A transceiver arrangement comprising a sound generator and a sound detector may be used for determining position information for each of the fixtures during a fixture position learning procedure. For example, the elevator car may travel to each of the floors, open either front or rear doors and transmit/generate a predefined sound signature. A fixture attached to the elevator will be listening for this sound signature during the learn mode. Once, a fixture recognizes this sound signature, it will inform for example a controller of the elevator of its unique ID. The controller may then either store this information locally or provide the location information to the fixture to be stored there, for example in EEPROM. As an alternative method, the sound detector may be located inside the elevator car. The sound generator may then be a device being installed in a hall fixture, for example as one of hall lanterns with a gong. In such case, the elevator car would travel to a floor and open one side door, then command the hall fixtures, one by one, to generate the sound signatures. The sound detector in the elevator car would detect the sounds from the hall fixtures located at the same floor and side, at which point the device in the elevator car would inform the controller of the elevator. The controller would then send the floor and site information to the last device which was commanded to generate the sound. The elevator would continue doing this on all floors until all of the fixtures have been detected. Such elevator may be commanded or pre-programmed to learn the locations of the fixtures during for example the night when no one is around. A same method may also be used to check for example the fixture function automatically, when doing a selftest.

Finally, it should be noted that terms such as “comprising” do not exclude other elements or steps and the “a” or “an” does not exclude a plurality. Also elements described in association with different embodiments may be combined.

In accordance with the provisions of the patent statutes, the present invention has been described in what is considered to represent its preferred embodiment. However, it should be noted that the invention can be practiced otherwise than as specifically illustrated and described without departing from its spirit or scope.

1-15. (canceled)

16. An elevator arrangement comprising:
a car that travels between various floors within a building;
an elevator control for controlling travel of the car between the various floors, the elevator control having information on a current position of the car;
a plurality of fixtures, each of the fixtures being located at one of the floors and being connected to the elevator control for an exchange of information;
a sound generator being positioned at the car and a plurality of sound detectors with each of the sound detectors being positioned at one of the fixtures, or a plurality of sound generators with each of the sound generators being positioned at one of the fixtures and a sound detector being positioned at the car; and
wherein the elevator arrangement performs a fixture position learning procedure comprising:
travelling the car to each of the floors; and
at each of the floors where the car is currently stopped using the sound generator positioned in the car or at the currently stopped at floor to generate a sound signal, detecting the sound signal using the sound detector positioned at the currently stopped at floor or in the car, and determining a position information for the fixture located at the currently stopped at floor by assigning the current position information from the elevator control to the fixture located at the currently stopped at floor and storing the position information for subsequent identification purposes.

17. The elevator arrangement according to claim 16 wherein, upon traveling the car to each of the floors, the elevator control stops the car at the travelled to floor.

18. The elevator arrangement according to claim 16 wherein, during performing the fixture position learning procedure, the elevator control opens a door of the car to establish a direct sound connection between an interior of the car the currently stopped at floor.

19. The elevator arrangement according to claim 16 wherein, during performing the fixture position learning procedure, the elevator control only partially opens or does not open a door of the car and a direct sound connection between an interior of the car and the currently stopped at floor is provided due to the car being stopped at the currently stopped at floor.

20. The elevator arrangement according to claim 16 wherein one of the sound detectors is positioned at each of the fixtures, wherein the sound generator is positioned in the car, and wherein, during performing the fixture position learning procedure, the position information is generated by assigning the current position information to a one of the fixtures at which the sound detector detects the sound signal with a sound pressure level higher than a sound level pressure detected at all others of the sound detectors.

21. The elevator arrangement according to claim 16 wherein the sound detector is positioned in the car, wherein one of the sound generators is positioned at each of the fixtures, and wherein, during performing the fixture position learning procedure, each of the sound generators generates the sound signal in sequence and the position information is generated by assigning the current position information to a one of the fixtures at which the sound generator generates the sound signal detected by the sound detector with a sound pressure level higher than a sound level pressure detected from all others of the sound generators.

22. The elevator arrangement according to claim 16 wherein each of the fixtures, when determining the position information, requests the information on the current position of the car from the elevator control and assigns the current position information to the fixtures and stores the position information for the subsequent identification purposes.

23. The elevator arrangement according to claim 16 wherein each of the fixtures, when determining the position information, transmits a unique identification information of the fixture to the elevator control and the elevator control stores the unique identification information for the subsequent identification purposes.

24. The elevator arrangement according to claim 16 wherein, in a normal operation mode, the elevator control identifies each of the fixtures based on the position information stored for the subsequent identification purposes during the fixture position learning procedure.

25. The elevator arrangement according to claim 16 wherein the fixture position learning procedure including the travelling of the car to each of the floors and the generating and detecting of the sound signals is performed automatically under control of the elevator control.

26. The elevator arrangement according to claim 16 wherein the car has at least two car doors and wherein, during the fixture position learning procedure, both car doors are opened at the stopped at floors sequentially and sound signals are generated and detected using the sound generator and the sound detector, respectively, positioned at the car and an associated one of the fixtures located at the floor where the car is currently stopped and where the car doors are currently opened.

27. The elevator arrangement according to claim 26 wherein the position information is determined by additionally correlating an information on which of the car doors is currently opened, the car door information being provided by the elevator control.

28. A method for determining position information for each of a plurality of fixtures of an elevator arrangement, the fixtures being located at various floors within a building, the method comprising the steps of:
travelling the car to and stopping the car at each of the floors;
when the car is stopped at each of the floors,
generating a sound signal using a sound generator positioned at one of the car and the fixture located at the floor where the car is currently stopped,
detecting the sound signal using a sound detector positioned at another the car and the fixture located at the floor where the car is currently stopped,
determining a position information for the fixture located at the floor where the car is currently stopped by assigning a current position information for the car from the elevator control to the fixture located at the floor where the car is currently stopped, and
storing the position information for subsequent identification purposes.

29. A computer program product comprising computer readable instructions which, when executed by a programmable elevator control, perform the method according to claim 28.

30. A non-transitory computer readable medium comprising the computer program product according to claim 29 stored thereon.
